(19) United States
(12) Patent Application Publication
(10) Pub. No.: US 2026/0290991 A1
(43) Pub. Date: Sep. 24, 2026

(54) OFF VEHICLE MOISTURE PURGE SYSTEM FOR BATTERY ENCLOSURES

(71) Applicant: GM Global Technology Operations LLC, Detroit, MI (US)

(72) Inventors: Ryan Patrick Hickey, New York, NY (US); Adam Jonathan Tallman, Auburn Hills, MI (US); Robel Kiflemariam, West Bloomfield, MI (US)

(21) Appl. No.: 19/087,965

(22) Filed: Mar. 24, 2025

(51) Int. Cl. H01M 50/333; B60L 53/16; H01M 10/48; H01M 10/52

(52) U.S. Cl. CPC H01M 50/333; B60L 53/16; H01M 10/48; H01M 10/52; H01M 2220/20

(57) ABSTRACT

A vehicle including a rechargeable energy storage system (RESS) including a RESS housing and at least one battery pack disposed within the housing. A purge air connector is configured to interface with an off-vehicle purge air source, the purge air connector being connected to the rechargeable energy storage system housing via a purge air connection. A controller is controllably coupled to the RESS and the purge air source. The controller is configured to reduce a moisture level within the RESS housing by providing air from the purge air source to the RESS housing through the purge air connection.

### INTRODUCTION

The subject disclosure relates to systems for purging moisture from a battery pack of a vehicle, and in particular to such systems using off-vehicle air sources.

Vehicle battery packs, such as those used in electric vehicles and hybrid electric vehicles typically include one or more battery components stored within a case. The battery components can be subjected to moisture accumulation within the case resulting from condensation, coolant, ambient liquids (e.g. rain) and the like. Most battery pack architectures do not include a solution for actively or passively removing liquids once the liquid has formed within the pack. The presence of liquid within the battery pack can impair the functionality of the battery packs and require increased maintenance and downtime of the battery systems

Accordingly, it is desirable to provide a system for purging moisture and liquids from a vehicle battery pack.

### SUMMARY

In one exemplary embodiment a vehicle including a rechargeable energy storage system (RESS) including a RESS housing and at least one battery pack disposed within the RESS housing. A purge air conduit is configured to interface with an off-vehicle purge air source, the purge air conduit being connected to the rechargeable energy storage system housing via a purge air connection. A controller is controllably coupled to the RESS and the off vehicle purge air source. The controller is configured to reduce a moisture level within the RESS housing by delivering air from the off vehicle purge air source to the RESS housing through the purge air conduit.

In addition to one or more of the features described herein the compressed air is drier than an air currently within the RESS housing.

In addition to one or more of the features described herein the RESS housing includes at least one vent, and wherein the at least one vent is configured to allow air within the RESS housing to pass out of the RESS housing in response to the air within the RESS housing exceeding a pressure of an ambient air surrounding the RESS housing by a threshold amount.

In addition to one or more of the features described herein the at least one vent includes a spring loaded, normally closed, vent.

In addition to one or more of the features described herein the at least one vent comprises a removeable panel.

In addition to one or more of the features described herein the purge air conduit is a component of a standardized charging port.

In addition to one or more of the features described herein the purge air conduit includes a purge air reservoir.

In addition to one or more of the features described herein the purge air reservoir includes a supplemental compressor.

In addition to one or more of the features described herein the purge air conduit includes an electrically powered air flow control valve, and wherein the electrically powered air flow control valve is controllably connected to the controller.

In addition to one or more of the features described herein the vehicle includes at least one moisture sensor at the RESS, the moisture sensor being configured to determine a humidity of air within the RESS.

In addition to one or more of the features described herein the at least one moisture sensor includes at least one machine learning based virtual sensor.

In addition to one or more of the features described herein the at least one moisture sensor includes at least one sensor disposed withing the RESS housing.

In addition to one or more of the features described herein the at least one moisture sensor includes at least one sensor disposed adjacent to the RESS housing.

In addition to one or more of the features described herein reducing the moisture level within the RESS housing by delivering air from the off vehicle purge air source to the RESS housing through the purge air conduit comprises displacing air within the RESS housing with drier air from the off vehicle purge air source.

In addition to one or more of the features described herein reducing the moisture level within the RESS housing comprises decreasing a condensation rate within the RESS housing using the off vehicle purge air, evaporating a standing liquid within the RESS housing into the off vehicle purge air, and continuously displacing the purge air with new off vehicle purge air for a duration.

In addition to one or more of the features described herein reducing the moisture level within the RESS housing comprises increasing a pressure within the RESS housing using the off vehicle purge air and draining at least a portion of a standing liquid through at least one vent.

In another exemplary embodiment a method for reducing moisture within a rechargeable energy storage system (RESS) of a vehicle, the method includes connecting an off-vehicle purge air source to a purge air connection of the vehicle using a vehicle connector. Purge air is continuously delivered from the off-vehicle purge air source to an RESS housing through the purge air conduit. Air is vented from within the RESS housing through at least one normally closed vent.

In addition to one or more of the features described herein, the method further includes storing purge air from the off-vehicle purge-air source within a purge air reservoir, and wherein continuously providing purge air from the on-vehicle purge air source to the RESS housing through the purge air conduits comprises connecting the purge air reservoir to the purge air connection.

In addition to one or more of the features described herein continuously providing purge air from an on-vehicle purge air source to an RESS housing through a purge air conduit comprises lowering a moisture content of air within the RESS housing to a negative condensation moisture level and evaporating a standing liquid in the RESS housing by maintaining the air in the RESS housing at the negative condensation level for a predetermined duration.

In addition to one or more of the features described herein the purge air conduit is incorporated as a component of a standardized charging port.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a rechargeable energy storage system moisture reduction system;

FIG. 2 is a schematically representation of an RESS using purge air to remove moisture;

FIGS. 3A and 3B illustrate a first example of reducing moisture by lowering humidity in an RESS; and

FIGS. 4A and 4B illustrate a second example of reducing moisture by evaporating a standing liquid within an RESS.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, the term controller refers to a system including at least a processor and a memory, with the system being configured to perform or cause to be performed at least one operation. The system can be a dedicated controller including a single purpose processor and memory, a general control including one or more modules for performing the operation, a distributed system including multiple controllers in communication with each other and configured to control the operation, or any similar system.

According to a general embodiment of the systems described herein, a hardware based solution is provided to actively purge moist pack air and formed liquids within a battery pack to an ambient environment using air from one or more pressurized air sources off of the vehicle. The pressurized air sources can include, but are not limited to, refilling/charging station compressors, quick charge systems including purge air capabilities, and the like.

The pressurized air is delivered to the vehicle through conventional airflow connectors, and into the battery pack through a purge air valve. A pressure of the air delivered to the battery pack can be controlled by a corresponding vehicle controller according to any established pressure and/or flowrate control method. In alternate examples, such as those where the off-vehicle source provides compressed air within known parameters, the compressed air may be provided The pressurized air forces existing air out of the battery pack through one or more vents.

The air delivered to the battery pack is drier (has a lower humidity) than the air within the battery pack and the ambient air. The relative dryness of the purge air decreases the humidity within the battery pack. When condensation liquid has already formed within the battery pack, or when liquid from another source is present in the battery pack, continued provision of relatively dry purge air through the purge air valve facilitates evaporation of the liquid. The evaporated liquid is then displaced out of the RESS as the relatively dry purge air continues to be delivered to the RESS.

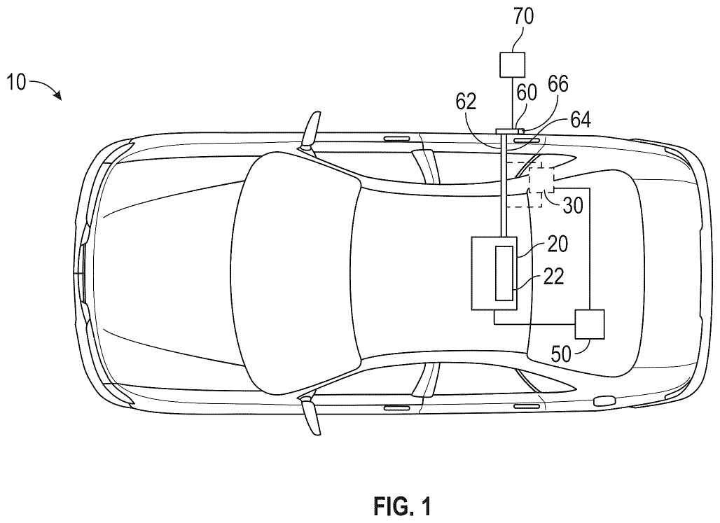

In accordance with an exemplary embodiment, FIG. 1 illustrates a vehicle 10 including a rechargeable energy storage system (RESS) 20. The RESS 20 includes, in one example, a housing containing at least one battery component 22. The RESS 20 is connected to a charging port 60 via an electrical connection 62 and via a purge airflow conduit 64.

The electrical connection 62 provides a conductive path for electric current to charge the battery pack 22 within the RESS 20 according to any conventional charging protocol. When charging is desired, an operator may connected a vehicle charger to the charging port 60, thereby providing an electrical charge from an exterior power source. In some examples, the charging is controlled in whole or in part via a controller 50.

In the example of FIG. 1, the purge airflow conduit 64 is a gas flow conduit able to interface with an off-vehicle compressed gas source 70 and receive a compressed gas at a connector 66. The connector 66, the compressed gas is delivered to the RESS 20 allowing an RESS 20 moisture purge to occur. In some examples, an optional purge air repository 30 may be incorporated with the purge airflow conduit 64 to store compressed purge air received therethrough. In such examples the purge air repository 30 may be incorporated in parallel to the purge airflow conduit 64 with electrically controllable valves connecting the purge air repository 30 to the airflow conduit 64 and allowing purge air to be redirected to the purge air repository. Air in the purge air repository may be stored for use in a moisture reduction operation at a later time.

In some examples, the purge airflow conduit 64 may be incorporated into a standardized charge system, and the off-vehicle compressed air source 70 may be incorporated into a charging station. In such examples, the vehicle 10 may accept purge air any time the vehicle 10 is charging, and a moisture purge may be operated during the charging process.

In alternate examples, the connector 66 may be positioned immediately adjacent the charging port 60 for ease of finding the connector 66, or elsewhere on the vehicle 10 with the positioning being determined by vehicle configuration.

In yet further examples, the purge air reservoir 30 may include a fan or other compressor component to provide supplemental pressurization when the off-vehicle purge air source 70 is not sufficiently pressurized. In some examples, one or more elements of a vehicle heating ventilation and cooling (HVAC) system may be utilized to provide the increased pressure.

A vehicle controller (controller 50) is in communication with each of the connector 66, the purge air reservoir 30 (when included) and the RESS 20. In some embodiments, the charge port 60 includes a communication protocol and communication between the controller 50 and the off-vehicle purge air source may be facilitated through the charge port 60 communications as well. The controller 50 is configured to effectuate the processes described herein according to any conventional control processes.

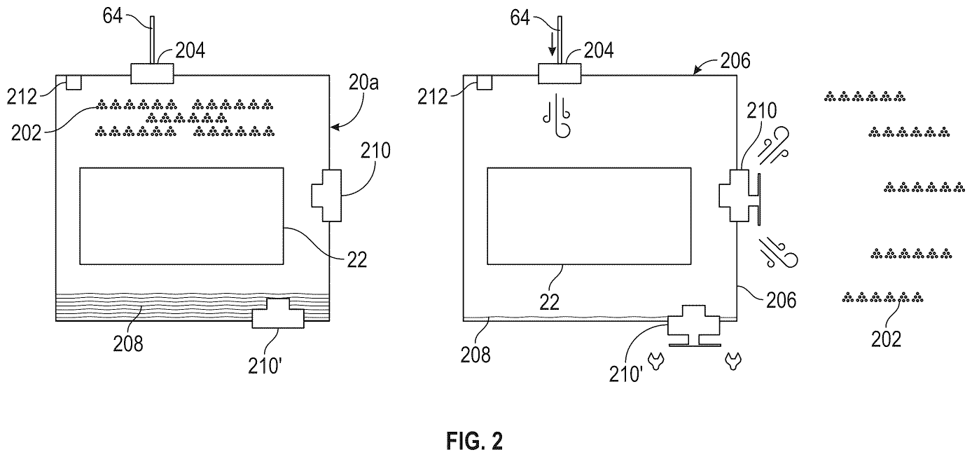

With continued reference to the vehicle of FIG. 1, FIG. 2 illustrates an RESS 20 in an initial state (RESS 20a) and in a purged state (RESS 20b). The RESS 20 includes at least one purge air inlet valve 204 connected to the purge air reservoir 30 or directly to the connector 66 via the purge air conduit 64. In alternate examples two or more purge air inlets 204 may be included with each being connected to the purge air reservoir 30 and/or the conduit 64. Multiple vents 210 are disposed in the walls and base of the RESS 20.

In some examples the vents 210 are normally closed vents configured to open when a pressure differential between the air pressure within the RESS 20 and an ambient environment exceeds a threshold level. In one such example, the vents 210 are spring loaded vents, and the threshold level is determined by the spring force of a spring within the vent 210.

In some examples, the vents 210 are permeable membranes that allow an amount of flow through the membrane. In such examples, continued application of pressurized air to the RESS 20 ensures that a flow of air from inside RESS 20 through the membrane to the ambient atmosphere is maintained, thereby preventing backflow.

In yet other examples, the vents 210 may include removeable panels configured to be removed by a maintenance technician at the start of a purge operation and replaced by the maintenance technician at the end of the purge operation.

In some examples the vents 210 are strategically placed on the RESS 20 to optimize fluid egress with respect to sensitive components (e.g., high voltage bussing, BDU etc.) that may be positioned adjacent to and/or near the RESS 20 on the vehicle 10.

In some examples, levels of moisture 202 and liquid 208 within the RESS 20 can be detected via sensors 212 within the RESS 20. In alternate examples, the moisture levels may be derived from other available sensor information.

In yet other examples, the moisture and liquid levels may be determined using a standard diagnostics and prognostics methodology in automotive applications. In some examples, the moisture and liquid levels may be determined using a machine learning based virtual sensor. As used herein a machine learning based virtual sensor refers to a machine learning based algorithm trained to receive a set of data and predict a likely internal moisture level of the RESS 20 based on the received set of data. In some examples one or more data elements within the set of data does not directly correlate to moisture levels. The machine learning algorithm may, in some examples, be trained in a laboratory environment using a combination of empirical and simulation based data.

When the moisture levels exceed a threshold, or when a drying process is initiated as part of a scheduled operation and/or manually initiated, purge air is provided through purge air conduit 64. The purge air flows into the RESS 20b. The incoming purge air displaces the moist air through at least one of the vents 210, decreasing the moisture levels within the RESS 20b.

When standing liquid 208 has accumulated in the RESS 20, the purge air can further remove the liquid, via evaporation in addition to displacing the moist air with drier air. Optionally, the liquid 208 can be removed through a vent 210′ positioned at a bottom wall (relative to gravitational forces) of the RESS 20. In this example, the increased pressure resulting from providing the drier air to the RESS 20 through the purge air conduit 64 can force the liquid 208 directly out through the vent 210'.

In another example, the standing liquid 208 can be purged from inside the RESS 20 through evaporation. As the purge air is drier than the ambient air, and drier than the air within the RESS 20, the purge air picks liquid from the standing liquid 208. Continued purging displaces the air including the evaporated liquid through the vents 210 thereby reducing or eliminating the standing liquid 208.

In some examples, the RESS 20 may utilize a combination of directly purging the liquid through a vent 210′ in a bottom wall and evaporative purging to reduce the amount of standing liquid 208.

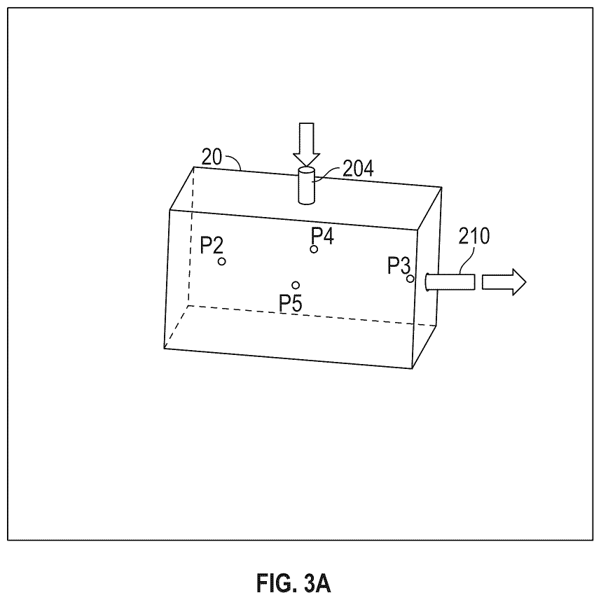

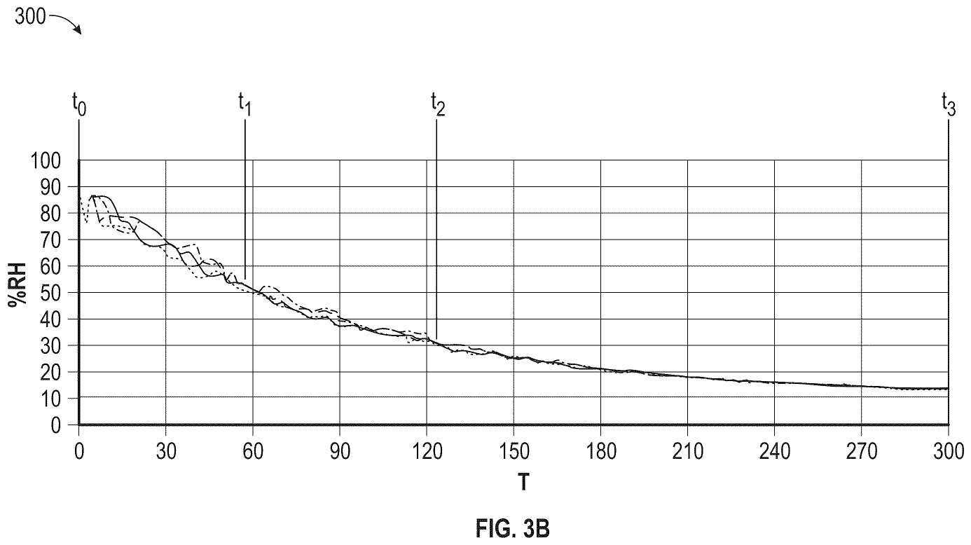

With continued reference to FIGS. 1-2, FIG. 3A schematically illustrates an RESS 20, including multiple humidity sensors (P2, P3, P4, P5). FIG. 3B is a chart 300 illustrating a humidity, measured as a relative humidity percent (RH %), over time of the RESS 20 of FIG. 3A as a purge process continues, in one example.

Immediately prior to the purge air cycle, at t0 (0 seconds), the initial air in the RESS 20 is at an average of 90% humidity and 25 degrees Celsius (C) as measured by the humidity sensors P2, P3, P4, P5. Puge air begins being delivered through the purge air inlet valve 204. In the example of FIGS. 3A and 3B, the purge air is provided from a pressurized purge air source with a relative humidity of 10% and at 25 degrees C. In one example, the purge air inlet valve 204 is an electrically powered and airflow control valve and is connected to the controller 50.

The pressurized purge air is continuously delivered to the RESS 20 and mixes with the initial air already inside the RESS 20. The mixed air is then displaced through the outlet valves 210 (schematically illustrated in FIG. 3A as a single outgoing airflow), thereby decreasing the average humidity of the air inside the RESS 20. The initial inrush of purge air provides a substantial reduction in humidity as shown from t0 to t1. As purge air is continuously provided to the RESS 20, the relative humidity within the RESS 20 continues to decrease, with the rate of decrease slowing resulting in the curve illustrated in chart 300. Once the relative humidity within the RESS 20 reaches the same relative humidity of the purge air being provided through the purge inlet valve 204 (at time t3), the decline levels off.

Continued provision of purge air after time t3 will maintain the lower relative humidity but will not continuously lower the relative humidity below the relative humidity of the air being provided.

In a practical implementation, the slope of the chart 300 through times t0, t1, t2, and t3 can be generally determined via empirical testing and/or simulations and the chart may be stored in the controller 50. Multiple individual charts 300 at each of multiple temperature combinations (purge air temperature and initial RESS 20 air temperature) may be stored and referenced by the controller 50.

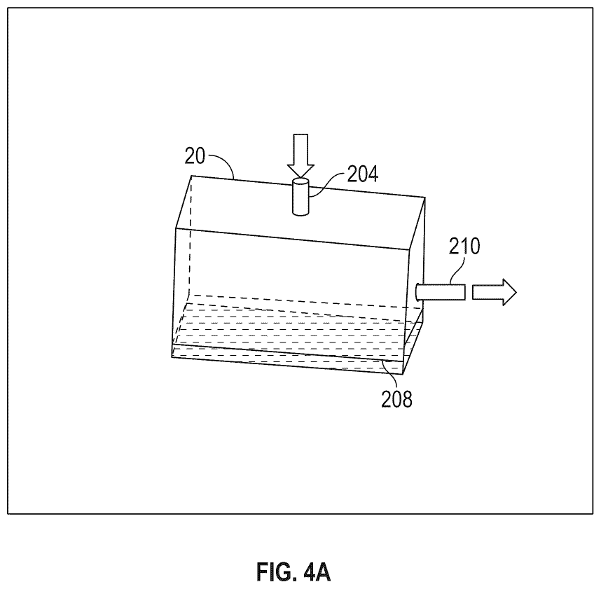

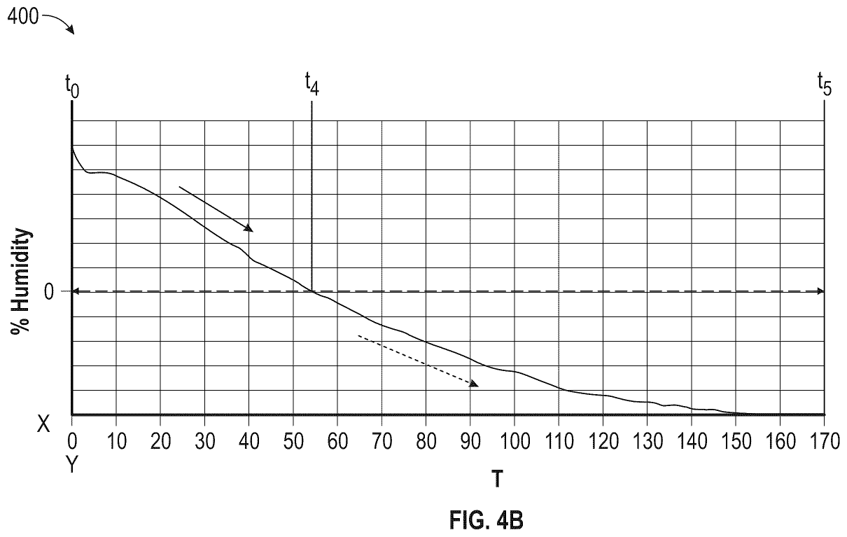

With continued reference to FIGS. 1-3B, FIG. 4A illustrates an RESS 20 having a liquid 208 accumulated therein. The liquid 208 is a result of condensation, incidental leakage through one or more vents 210 and/or any other liquid source. FIG. 4B illustrates a chart 400 of condensation rate (Y axis) over time (X axis). At an initial time (T0) the humidity level is high (see FIGS. 3A, 3B) and the condensation rate is similarly elevated driving an continued increase in the level of liquid 208 within the RESS 20 due to condensation.

As purge air is delivered through the purge air inlet valve 204, the condensation rate decreases due to the decreased moisture content in the air, until a time (t4) where the condensation rate approaches 0. After reaching 0, the condensation rate continues to drop below 0, resulting in evaporation (i.e., negative condensation). Continued delivery of the drier air through the purge air inlet valve 204 will continue to drive evaporation until a maximum evaporation (minimum condensation) point is reached at t5.

As can be appreciated the maximum evaporation point t5 may be impacted by multiple factors including a dew point and it not necessarily the same point in time as the time (t3, chart 300 of FIG. 3B) where the RESS 20 reaches a minimum relative humidity. In such cases, the duration of a purge may exceed an amount of time required to reduce the humidity of the air within the RESS 20.

Referring again to FIGS. 1-2, In some examples, the sensors 212 may be utilized to detect moisture levels and provide the detected moisture level to the controller 50. In such examples, when the moisture level exceeds a predefined threshold the controller 50 provides a service notification to a vehicle operator indicating that liquid is present in the RESS 20. In some examples, the operator may then schedule the vehicle for maintenance and a purge may be provided during the maintenance. In alternate examples the operator may perform the purge using any off-vehicle purge air source.

In yet further examples, removing moisture from the RESS 20 using the purge air process may be operated as routine preventative maintenance and included in periodic scheduled maintenance, much the same as an oil change.

In some examples, the maintenance may include removal of one or more side panels of the RESS 20 before beginning the purge process. In this example, one or more of the vents 210 positioned on the side of the RESS 20 includes a panel portion connecting the vent 210 to the walls of the RESS 20. By removing the vent, including the panel portion, the flow rate of the purge air through the RESS 20 can be substantially increased, thereby decreasing a required time to achieve the evaporation process.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a rechargeable energy storage system (RESS) including a RESS housing and at least one battery pack disposed within the RESS housing;
a purge air conduit configured to interface with an off-vehicle purge air source, the purge air conduit being connected to the rechargeable energy storage system housing via a purge air connection; and
a controller controllably coupled to the RESS and the off-vehicle purge air source, the controller being configured to reduce a moisture level within the RESS housing by delivering air from the off-vehicle purge air source to the RESS housing through the purge air conduit.

2. The vehicle of claim 1, wherein the compressed air is drier than an air currently within the RESS housing.

3. The vehicle of claim 1, wherein the RESS housing includes at least one vent, and wherein the at least one vent is configured to allow air within the RESS housing to pass out of the RESS housing in response to the air within the RESS housing exceeding a pressure of an ambient air surrounding the RESS housing by a threshold amount.

4. The vehicle of claim 3, wherein the at least one vent includes a spring loaded, normally closed, vent.

5. The vehicle of claim 3, wherein the at least one vent comprises a removeable panel.

6. The vehicle of claim 1, wherein the purge air conductor is a component of a standardized charging port.

7. The vehicle of claim 1, wherein the purge air conductor includes a purge air reservoir.

8. The vehicle of claim 7, wherein the purge air reservoir includes a supplemental compressor.

9. The vehicle of claim 1, wherein the purge air conductor includes an electrically powered air flow control valve, and wherein the electrically powered air flow control valve is controllably connected to the controller.

10. The vehicle of claim 1, wherein the vehicle includes at least one moisture sensor at the RESS, the moisture sensor being configured to determine a humidity of air within the RESS.

11. The vehicle of claim 10, wherein the at least one moisture sensor includes at least one machine learning based virtual sensor.

12. The vehicle of claim 10, wherein the at least one moisture sensor includes at least one sensor disposed withing the RESS housing.

13. The vehicle of claim 10, wherein the at least one moisture sensor includes at least one sensor disposed adjacent to the RESS housing.

14. The vehicle of claim 1, wherein reducing the moisture level within the RESS housing by delivering air from the off vehicle purge air source to the RESS housing through the purge air conduit comprises displacing air within the RESS housing with drier air from the off vehicle purge air source.

15. The vehicle of claim 1, wherein reducing the moisture level within the RESS housing comprises decreasing a condensation rate within the RESS housing using the off vehicle purge air, evaporating a standing liquid within the RESS housing into the air, and continuously displacing the air with new off vehicle purge air for a duration.

16. The vehicle of claim 1, wherein reducing the moisture level within the RESS housing comprises increasing a pressure within the RESS housing using the off vehicle purge air and draining at least a portion of a standing liquid through at least one vent.

17. A method for reducing moisture within a rechargeable energy storage system (RESS) of a vehicle, the method comprising:
connecting an off-vehicle purge air source to a purge air connection of the vehicle using a vehicle connector;
continuously providing purge air from the off-vehicle purge air source to an RESS housing through a purge air conduit; and
venting air from within the RESS housing through at least one normally closed vent.

18. The method of claim 17, further comprising storing purge air from the off-vehicle purge-air source within a purge air reservoir, and wherein continuously providing purge air from the on-vehicle purge air source to the RESS housing through the purge air conduit comprises connecting the purge air reservoir to the purge air conduit.

19. The method of claim 17, wherein continuously providing purge air from an on-vehicle purge air source to an RESS housing through a purge air conduit comprises lowering a moisture content of air within the RESS housing to a negative condensation moisture level and evaporating a standing liquid in the RESS housing by maintaining the air in the RESS housing at the negative condensation level for a predetermined duration.

20. The method of claim 17, wherein the purge air conduit is incorporated as a component of a standardized charging port.
